(19) United States
(12) Patent Application Publication
(10) Pub. No.: US 2019/0213638 A1
(43) Pub. Date: Jul. 11, 2019

(54) CONNECTED DEVICES TRACKING AND CONTENT DELIVERY SYSTEM

(71) Applicant: BBY SOLUTIONS, INC., Richfield, MN (US)

(72) Inventor: Matthew Hurewitz, Minneapolis, MN (US)

(21) Appl. No.: 15/863,455

(22) Filed: Jan. 5, 2018

(51) Int. Cl. G06Q 30/02

(52) U.S. Cl. CPC G06Q 30/0261; G06Q 30/0269

(57) ABSTRACT

Techniques and system configurations for providing content to a mobile device based on smart device activity data, user data, and third-party vendor data. The techniques include receiving device data that is collected from operation of a smart device in a customer dwelling, and receiving vector data associated with a content output. Based on the device data received, and the vector data, media content related to the smart device may be provided to, and output from, an output device (including the monitored smart device).

### TECHNICAL FIELD

Embodiments pertain to processing activities of a network-connected device information system. Some embodiments pertain to techniques to correlate device activity (and related user activity) to later activities and uses of the connected device.

### BACKGROUND

Smart home devices are becoming prevalent in the marketplace. Whether a smart TV, sound system, curtains, refrigerator, oven, garage door, washing machine, dryer, coffee pot, thermostat, or the like, users enjoy being able to control their home devices remotely from other devices. In this manner, a user can warm their home, lock their front door, start dinner, monitor food levels, or the like, while in remote locations. This adds convenience and saves time for individuals busy with other life activities.

As technology advances and user behavior changes because of the use of smart devices, content providers are constantly searching for new and better ways to reach users with more accurate information. With smart devices now communicating remotely with other devices and users over the internet of things (IoT), significant amounts of trackable user data associated with the smart devices is now being generated that can assist in creating customized materials for users. However, effectively collecting and utilizing this information is problematic and generally ineffective to result in improved marketing and information targeting.

As an example, some monitoring systems exist that are directed toward determining timing of advertising outputs. A smart refrigerator may include sensors that monitor the opening and closing of the refrigerator door and that outputs an advertisement on a display in response to the door being opened. While this effectively presents the advertisement at a time when a potential user is present in the location of the refrigerator, whether the content of the advertising is relevant to the particular user or the user's activities and interests is completely random and left to chance.

### BRIEF DESCRIPTION OF THE DRAWINGS

FIG. 1 illustrates smart device interactions in a real-world environment according to an example described herein.

FIG. 2 illustrates an overview of a smart device content system according to an example described herein.

FIG. 3 illustrates communications between smart devices and device monitoring and content delivery systems in an Internet of Things media network according to an example described herein.

FIG. 4 illustrates an example hierarchy of content selection vectors defined for a user in an Internet of Things media network, according to an example described herein.

FIG. 5 illustrates an example use of content selection vectors for content delivery to a user in an Internet of Things media network, according to an example described herein.

FIG. 6 illustrates an example scenario of accessing activity-customized content in an Internet of Things media network using a software application, according to an example described herein.

FIG. 7 illustrates an example method performed by a computing device for content retrieval in an Internet of Things media network, according to an example described herein.

FIG. 8 illustrates an example method performed by monitoring and content selection subsystems for content delivery in an Internet of Things media network, according to an example described herein.

FIG. 9 illustrates a block diagram of example computing system components adapted for interaction with an Internet of Things media network, according to an example described herein.

FIG. 10 is a block diagram illustrating operational components of a computing system upon which any one or more of the methodologies herein discussed may be run.

### DETAILED DESCRIPTION

The following description and drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

The term “smart device” when used in the context of this application refers to any device that has or performs some intelligent (e.g., electronically controlled, sensed, or actuatable) feature and is in connection with other devices and systems via a communications network, such as connectivity to other hosts including other edge devices and cloud services via the Internet of Things (loT). Communication networks that may be utilized with such smart devices can include a personal area network (PAN), a local area network (LAN), a wide area network (WAN), the Internet, mobile telephone networks, plain old telephone (POTS) networks, and combinations of wired or wireless data network topologies (including Bluetooth, Wi-Fi, 2G/3G, 4G LTE/LTE-A, or 5G networks). Thus, references to the “Internet of Things” or IoT may encompass any number of device-to-device, personal, local, or wide area network topologies. Example features of such smart devices may include sensors, actuators, graphical displays, text or audio human-machine interfaces, and the like. Examples of smart devices include, but are not limited to televisions, sound systems, speakers and speaker/microphone combinations, curtains, refrigerators, ovens, garage doors, washing machines, dryers, coffee pots, thermostats, smart locks, connected speakers, audio or media player devices, pedometers, weight scales, pill dispensers, toothbrushes, personal health monitoring devices, automobiles (or other transportation vehicles), human-interactive control systems within such vehicles, or like devices. Some smart devices may include complex processing circuitry and logic, with capabilities approaching smartphones or computing systems; other smart devices may have very limited capabilities, and rely on remote processing instructions and logic. Further, a personal computer, tablet, or smartphone may be configured in some examples to operate as a smart device.

Some of the examples discussed herein are directed to techniques that enable identification of real-world user activities and tracking information from a user's specific engagement and use of smart devices. These user activities are identified for correlation with subsequent content selection and delivery techniques from a media delivery system. In one example, the described techniques enable a commercial entity (e.g., a smart device manufacturer, a retailer, an internet service provider, a media content provider) to collect and process useful commerce information including user data and device usage data related to the smart home device(s). This useful commerce information may be retrieved, collected, organized, and processed for the retrieval and delivery of other information, such as advertisements, interstitial advertisements, and other media content, which are selected and delivered on the basis of the real-world, real-time user data and device usage data.

In some of the examples further described herein, applicable vectors may be organized, analyzed, and processed in a content system (such as an IoT media platform), and used with algorithms that determine subsequent media content to provide to the user through an IoT channel or another computing device. As an example use of such a vector, the content system receives and stores user data, to deliver content based on factors including but not limited to demographic data such as age, sex, residence, and the like, and ownership data such as number of smart devices, types of smart devices, age of smart devices, and the like. Such vector data may be collected and determined from across multiple smart device providers and smart device control services. As an example of another vector, the content system also constantly monitors usage data from each smart device, to deliver content based on usage factors including but not limited to, usage time, usage duration, usage periods during a 24-hour period, location data, device specific functioning such as temperature settings, power usage, sound level, and the like. Media content may be selected for the mobile computing device based matches between the received device data and the vector data, including through use of at least one algorithm to determine the media content. A feedback loop and aspects of artificial intelligence may also be utilized to enhance or modify, an algorithm when targeted media content results in some user activity.

As will be further explained below, these monitoring, analyzing, and media delivery examples may be further integrated with a variety of user interfaces, advertising networks, and with the use of user profiling and monitoring systems. This user, smart device, and vendor data may be correlated to media content delivery information and the selection and control of media content including but not limited to customized advertisements, audiovisual content, software content, and like information offerings.

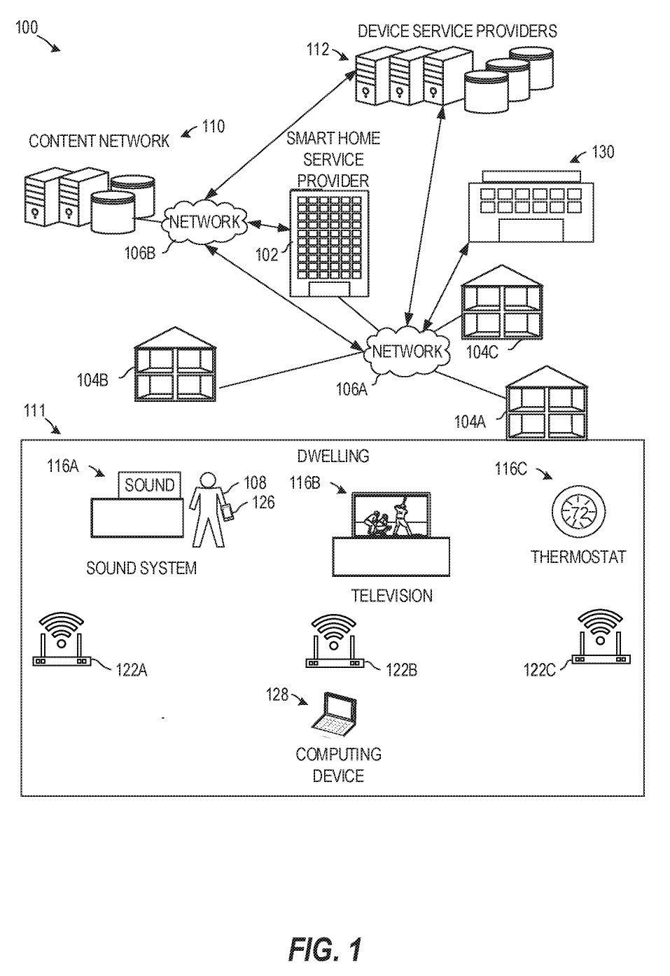

FIG. 1 provides a system illustration 100 of electronic interactions among system entities to obtain relevant user, device, and vendor data to provide targeted content to users based on IoT activity. The system 100 includes a smart home service provider 102 (e.g., manufacturer, retailer, internet provider, etc.) that is connected to a plurality of user dwellings 104A-104C via a network 106A. The user dwelling 104 is of any type that utilizes smart devices and includes but is not limited to single family residences, apartments, condos, commercial buildings, office buildings, strip malls, and the like. While only three dwellings 104A-104C are illustrated, numerous dwellings are possible within any given networked system. In each dwelling, a user 108 has control over access to the information within the electronics and devices within the dwelling. In this manner, permission or a key (e.g., an API key, password, etc.) is provided to the smart home service provider 102 to access information from electronics and devices within the dwelling 104. In some examples, the smart home service provider 102 may perform a network connection directly to devices within the dwelling; in other examples, the smart home service provider 102 may perform a network connection to a variety of device service providers 112 (e.g., cloud web services) which host network-accessible interfaces for IoT device monitoring and control.

The information from the IoT devices from a specific dwelling 106 and general user profile data is collected and received by the smart home service provider 102 and forwarded, as appropriate, via a network 106B to a content network 110 for information processing. The content network 110 may store such data in a data warehouse 114 after processing. The data collected by the content network 110 may have information that includes, but is not limited to, user profile data such as user or account identifiers, demographic data like age, sex, residence, and the like, and user ownership data such as number of smart devices, types of smart devices, age of smart devices, and the like. Such information may also include smart device usage data such as usage time, usage duration, usage periods during a 24-hour period and/or other period, location data, device specific functioning such as temperature settings, power usage, sound level, and the like. Such information may also include vendor data such as product data, new product release data, promotional or advertisement content, and the like.

Information is generated at each dwelling 104 that is sent to the smart home service provider 102, content network 110, device service providers 112, and other entities (such as a data warehouse, other content networks, etc.). Specifically, each dwelling has at least one smart device 116A-C. In the example of FIG. 1 only dwelling 104A is shown as having the smart devices 116A-C, but this is for illustration purposes only. Additionally, while three smart devices 116A-C are illustrated, any number of smart devices, including only one and up to several hundred in instances where the dwelling is an office building, may be present. The smart devices illustrated include a smart audio system 116A (e.g., smart speaker with an AI agent), smart TV 116B, and smart thermostat 116C. These smart devices are merely examples and the smart devices 116 may include any type of device, including the other IoT device examples discussed herein.

Each smart device 116A-C may include one or more processors and one or more memory devices, and communication circuitry to communicate with the device service providers, the smart home service provider, a local hub, or other devices. For instance, in the example of FIG. 1, each smart device 116A-C is coupled to one or more Wi-Fi access points 122A-C that transmits device data to the network 106A. Consequently, data obtained by each smart device 116A-C is communicated through the system networks 106A, 106B (in addition to other networks not shown) to the smart home service provider 102, content network 110, and device service providers 112, for processing, organization, analysis, and use. Data includes, but is not limited to device model number, installation date, owner name, geographic location, operation settings such as temperature settings, volume settings, wash settings, and the like, usage data including duration of use, periods of use, use parameters, and the like.

A mobile computing device 126 and secondary computing devices 128 of the user 108 may also be connected to each smart device 116A-C, directly through device-to-device communications (e.g., Bluetooth connections), through the local area network (e.g., via Wi-Fi access points 122A-C), or through a wide area network (e.g., through network 106A to a cloud API of the device service providers 112). The mobile computing device 126 may be a smartphone, dedicated device, wearable device, or other electronic device or medium that can be used to receive and transmit data, including receipt of notifications and advertising media. The secondary computing device 128 includes but is not limited to a second smartphone, dedicated device, wearable device, laptop, or the like that is also able to transmit and receive data including targeted advertising media. Such devices 126, 128 may be tracked by the smart home service provider 102 or the content network 110 for association with the smart devices 116A-C.

A plurality of third party vendors 130 may receive access to user data and device data via a private network connection 106A or 106B with the smart home service provider 102, the content network 110, or the device service providers 112. Through this connection, the smart home service provider 102, for example, may receive vendor data about products and potential marketing opportunities related to vendor products. Specifically, the third-party vendors 130 provide product information via the network connections 106A or 106B to the content network 110 and the device service providers 112, so such data is able to be organized, analyzed, and processed within the overall system to generate the media advertisements sent to a user device 126, 128 or on the IoT devices 116A-C. This includes information regarding new products, new uses of products, assistance or service information, product promotions, targeted content related to demographics of users who use the IoT devices, and the like.

Thus, based on the data transmitted to the content network 110, device service providers 112, and smart home service provider 102, determinations are made based on selected vector (e.g., user, device, time, location, and vendor) data to determine future content selections (e.g., from the vendor 130). In another example, the data and correlation determinations are generated or supplemented by a third party (not shown). Based on the correlation determinations, the system creates targeted notifications, advertising, and other content for the user 108. The type of content, time periods to advertise or deliver the content, which device to receive the content, and the like is thus determined based on the correlation generated by the algorithms, processors, analysis, and the like, as discussed in the following examples.

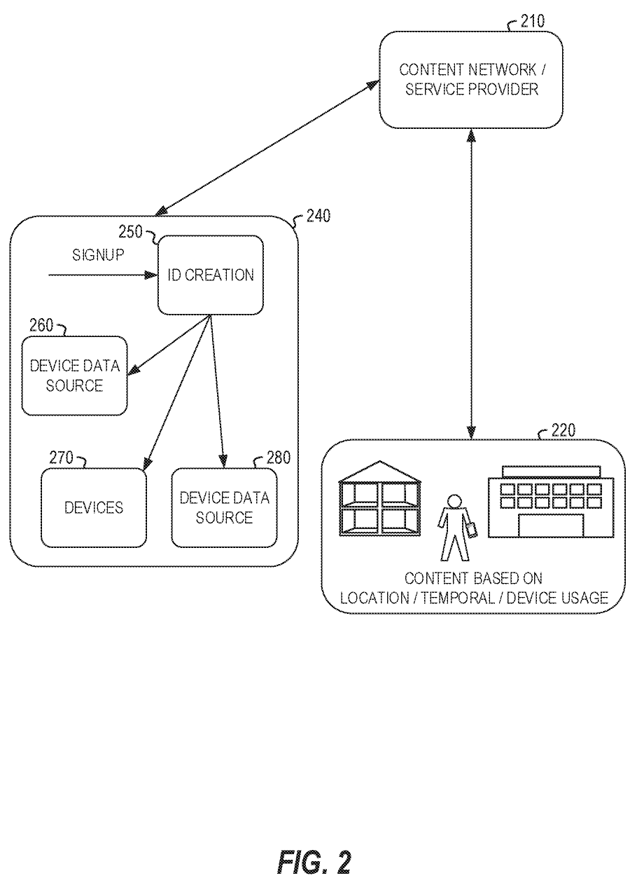

FIG. 2 illustrates an overview of a smart device content system according to an example. As a simplified example of the scenarios depicted in FIG. 1, a content network or service provider 210 (e.g., the smart home service provider 102, the content network 110, the device service providers 112) may deliver content 220 to a user based on location characteristics (e.g., the location of the IoT device, the location of the user relative to the IoT device, or the location of the user at a subsequent time), temporal characteristics (e.g., the time of day, how long the user has utilized the IoT device, how long the IoT device has existed in a particular state), or device usage (e.g., the user commonly adjusts the IoT device, has a complex scenario of connected IoT devices, etc.).

The smart device data 240 that is collected on behalf of the user may include data from multiple device data sources 260, 280 (e.g., cloud services), or from devices directly 270 (e.g., on demand). Such device data 240 may be specifically associated with an identifier creation 250, such as an identifier established when a user performs a signup or subscription of a service with a smart home service provider. This identifier is used to correlate specific combinations of device data sources and devices with a particular user, allowing a more complex view of a set of devices that a particular user owns and operates. In a further example, the user being tracked by the identifier may include a family or group of users, or a collection of related users.

The following paragraphs discuss various example scenarios involving content delivery and targeting based on IoT device activity. It will be understood that the following examples are provided for purposes of illustration, and many of the following examples may be combined or integrated with each other.

As a simple example, consider a scenario where a user has a smart refrigerator in communication with a smart device monitoring platform. The smart device monitoring platform continually receives energy consumption data of the refrigerator. When the energy consumption increases above a threshold energy consumption level for a pre-selected duration of time, or alternatively indicates an error or warning status (such as compressor failure, broken ice maker, etc.), the app determines based on this usage data that the refrigerator requires maintenance or replacement. Media content related to refrigerator repair and service may be selected and delivered to devices of the user, including but not limited to the refrigerator itself, other smart devices in the home (e.g., smart speaker), a user's mobile computing device used to monitor the smart device, or other owner secondary computing devices such as laptop computers, a smartphone of a family member, or the like. Such content may be delivered directly in apps associated with the smart device or smart home control, or in other apps entirely (e.g., shopping apps, news or entertainment apps, etc.).

In another example, the smart device monitoring platform receives usage data related to a smart coffee machine of a user. Such usage data indicates that the user uses the coffee maker between 9:00 and 9:10 A.M. consistently every weekday and a correlation between coffee drinking and browsing the internet exists. Thus, when this data is collected and processed, an algorithm determines the pattern of the user always making coffee during the same period every week day. The system then correlates this pattern data to targeted media content and sends the media content for consumables related to coffee to user devices, including the mobile computing device or secondary computing devices used to browse the internet during the 9:00-9:10 A.M. time period.

In yet another example, user data stored and collected by the smart device monitoring platform indicates that the user has two smart thermostat devices in use in their home from a particular manufacturer. When third-party data is received that a new version of the smart thermostat device becomes available, or another product (e.g., a security camera) that is complimentary to the smart device vendor ecosystem, content is selected to advertise this new product to the user. The smart device monitoring platform correlates the vendor and user data and sends an advertisement or push notification for the new product to the user's IoT device, a computing device, or a secondary computing device.

In another example, the user has a complex home automation scenario that involves a smart TV, smart audio system, and smart lights. Based on this user data, the smart device monitoring platform provides a push notification for a period of time regarding complimentary smart products such as smart curtains or blinds that are compatible with for control. Such notifications may be targeted according to the user's likelihood to purchase, such as notifying near holiday or birthday gift purchasing times, based on promotions or sales of the product by a retailer, or based on external factors (such as during the summer, during warm and sunny days, etc.). As in the examples above, such notifications may be provided to the IoT devices (e.g., a connected media player device), the user's primary computing device (e.g., a smartphone), or secondary computing devices.

In another example, device usage data related to a smart oven is collected, analyzed, and processed to result in the selection and determination of targeted advertising media by the smart device monitoring platform. In the example, the smart oven is operated during weekends, over a six-month period, in an amount of time that exceeds a calculated average time of usage of other smart ovens during that same six-month period. The smart device monitoring platform correlates the processed usage data to determine that the user regularly bakes as a hobby. Based on the correlation, suitable media content related to cooking appliances, cooking tips, recipes, or the like is then sent by the system to the mobile computing device and secondary devices based on this determination.

In another example, user data maintained by the smart device monitoring platform indicates the user operates a certain brand of smart coffee maker from a particular manufacturer. In this example, another manufacturer introduces a new product that is compatible or adaptable to the user's smart coffee maker (e.g., a smart coffee grinder). When the smart device monitoring platform receives vendor data regarding an availability of the new product, the system correlates the vendor data with the user data. Consequently, the app sends a push notification to a computing device and/or secondary computing devices of the user, with a notification related to the new product.

In another example, an app associated with the smart device monitoring platform receives information regarding use of a smart washing machine, and communicates this information to the platform. An algorithm operated by the smart device monitoring platform determines periods of non-use compared to a pre-selected threshold use time during a period of use. Based on exceeding the use time threshold for a period, media content related to consumables such as laundry detergent or dryer sheets may be sent to the user's mobile computing device and/or secondary computing devices.

In another example, the smart device monitoring platform receives device data related to when a smart garage door is opened and closed in the morning and in the evening. The smart device monitoring platform may determine that the opening and closing correlates to a common work schedule (e.g., during weekdays). Based on the opening and closing of the garage door, the timing of sending media content may be altered. Media may be sent only to secondary computing devices such as laptop computers typically only found in the home in the morning before the garage door is closed or in the evening after the garage door is open.

In another example, the smart device monitoring platform receives device data from a particular smart device such as a smart coffee maker indicating everyday use. The smart device monitoring platform is also linked with an app or service that receives user location data from a mobile computing device or secondary computing device. When the mobile computing device or secondary computing device is determined by the app to be moving and comes within a pre-selected distance of a specific store, or of a store having coffee products, the media content is sent to that computing device.

In another example, the smart device monitoring platform receives device data related to a set temperature of a smart thermostat for when a user is typically in a house. If the temperature in a given period is in a range above an average set temperature for all smart thermostat users, push notifications are provided that are related to operation of the heating appliances, such as usage tips, service suggestions, or the like. Such push notifications may be sent to the user's IoT devices or device interfaces associated with the heating usage (e.g., the smart thermostat, an app used to control the smart thermostat on a user's tablet), or mobile computing device and/or secondary computing device.

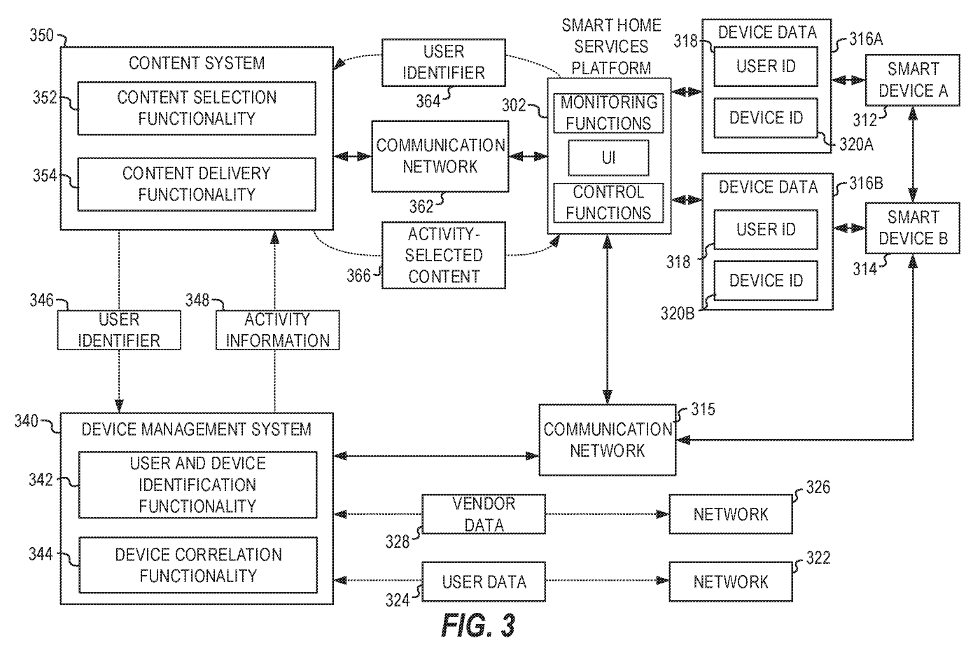

FIG. 3 illustrates interactions of a smart home services platform 302 with smart device monitoring and content delivery systems to access activity-based content in an IoT media platform according to an example. As shown, the smart home services platform 302 includes monitoring and control functions, in addition to a user interface (and other functionality and features not shown). The smart home services platform 302 operates to interact with various smart devices within a user dwelling, such as smart-device A 312 and smart device B 314 that provide device related data 316. The device related data 316 may be directly provided to the smart home services platform 302, or may be provided through a device management system 340 (e.g., a cloud service) via a network 315. The device data 316 may include a unique user identifier 318 and unique device identifiers 320A-B.

The device management system 340 operates to provide device and user identification functionality 342 and device correlation functionality 344, such as for multiple devices (and device identifiers, user identifiers) of a user among multiple IoT service platforms (e.g., multiple cloud services from different manufacturers and device ecosystems). The user identification functionality 342 operates to identify a specific user/profile of the user, based on a device identifier, account identifier, user identifier, or the like. The device correlation functionality 344 operates to correlate a specific set of data tracked for a user to the monitored smart devices, and utilizes a user identifier 346 to track this set of information.

In an example, the device management system 340 also operates to interact with an external or third party network 322 that provides another source of user related data 324 (e.g., based on the unique user identifier 346), such as user profile, demographic, or activity data. Similarly, the device management system 340 is optionally connected via a network 326 to a third-party vendor or content source (e.g., an advertising source), to obtain third party vendor data 328 for the device management system 340.

As a result of the IoT activities occurring among the smart device A 312 and smart device B 314, usage or activity data related to time periods of a specific user may be tracked. For example, a user identifier 318 may be associated with data that indicates that smart device A 312 is operating according to a certain condition. The device management system 340 may maintain the user identifier 346 as a separate (e.g., unique) identifier, that tracks a combination of data collected from among the smart devices 312, 314, the vendor data 328, and the user data 324.

FIG. 3 further illustrates the data operations to access customized information from the content system 350 (e.g., a media network such as is designed for serving advertisements or other media content) as a result of the user, device, and/or vendor data. For example, the smart home services platform 302 may provide a user identifier 364 to the content system 350 as part of a request for IoT-activity-customized advertisements. The content system 350 includes content selection functionality 352 that operates to determine the most appropriate content based on prior data received from the smart devices 312, 314, and vectors defined for the selection of content. The content selection functionality 352, for example, may operate to select information based on the user identifier 346, according to correlation with vectors that match user demographics, device activity in a dwelling, device status, and other such related activity information 348. For example, the content system 350 may select information from the device management system 340 based on the user identifier 346 which is associated with particular device activities, events, and user profile information.

The content system 350 further includes content delivery functionality 354 that operates to deliver the activity-selected content 366 to the smart home services platform 302 via the communications network 362 (which in turn, may propagate this information to the smart devices, a computing device, or a secondary device, or other output medium). The activity-selected content 366 may be directly displayed within the user interface of the smart home services platform 304 or may be further customized, refined, or processed within the platform 304, or within features of the output smart device or computing devices.

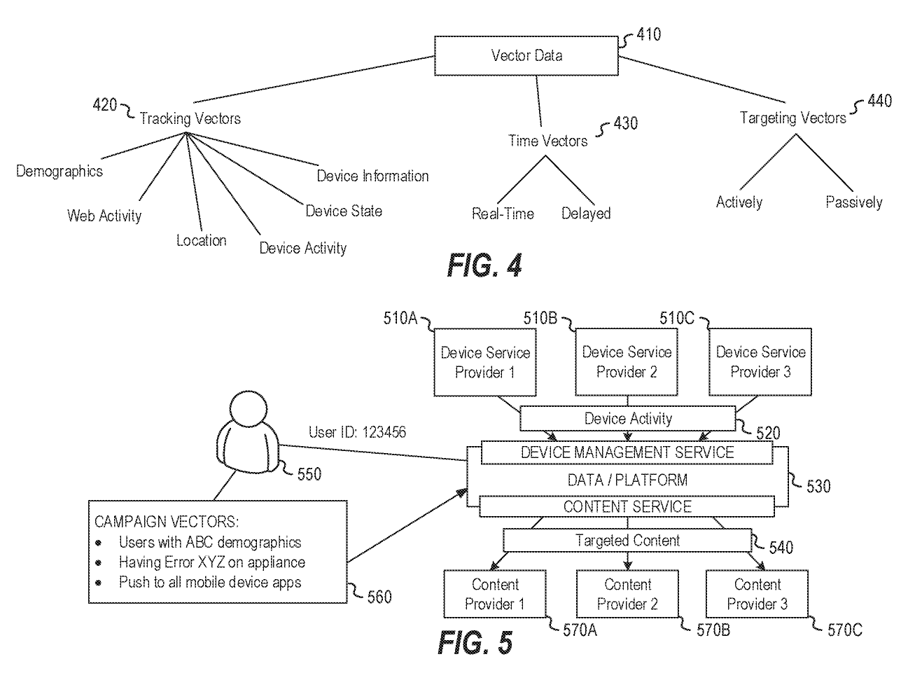

FIG. 4 illustrates an example hierarchy of content selection vectors defined for a user in an Internet of Things media network. Such vectors may be used to define the characteristics of content delivery and selection, such as discussed below in the example of FIG. 5.

As shown in FIG. 4, vector data 410 may include various sets of vectors, including tracking vectors 420, time vectors 430, and targeting vectors 440. Such tracking vectors 420 may include: demographics, web activity, location (user location, device location, etc.), device activity, and device information. Such time vectors 430 may specify real-time delivery and selection of content (e.g., immediately in response to some IoT device condition), or delayed delivery and selection (e.g., when a user visits a certain location, or at a particular time of day). Such targeting vectors 440 may specify whether the targeting is to perform active targeting or passive targeting (e.g., the amount of advertisements or notifications, whether such content is repeatedly delivered across multiple networks, or whether more content should be shown if the content is engaged or interacted with). Other combinations or organizations of vector data may also be deployed.

FIG. 5 illustrates an example use of content selection vectors for content delivery to a user in an Internet of Things media network. As shown, a user 550 is associated with a user identifier (e.g., “User ID 123456”), which is tracked within the IoT media platform 530. The IoT media platform 530 may include a device management service, content selection and delivery service, and thus multiple entities coordinating such services, in any of the forms discussed above for FIGS. 1 to 3.

The IoT media platform 530 receives a set of campaign vectors in order to select, target, and deliver content according to a defined set of vectors. The vector data in the campaign vectors 560 may specify, for example, a combination of tracking vectors (inclusion of users with certain demographics, having a certain error on a certain type of appliance, performing a certain IoT device activity); the vector data 560 may further specify timing and the type of devices used to deliver and output the content.

Device activity data 520 is collected from among the multiple device service providers 510A, 510B, 510C, to the IoT media platform 530. The vectors are used by the IoT media platform 530 to select a set of targeted content 540 that match the characteristics of the campaign vectors 560. This targeted content may be distributed via one or more content providers 570A, 570B, 570C, such as via multiple IoT cloud services, via internet advertising networks, via smart home control or assistance services, and the like.

In an example, a trigger for the targeted content 540 may be based off of more than one value for each vector, including vectors applicable to different types of devices, content providers, and smart device conditions. For instance, consider the case where a smart refrigerator is used three times per day to dispense water, with the smart refrigerator indicating a status that a water filter needs to be changed. This user owns five or more unique smart devices, but a specific content provider (e.g., provider 570A) wishes to target the user on their mobile phone when the use is at a location in proximity to a particular retail store that carries a particular brand and type of water filter. The campaign vectors 560 may be customized to deploy this campaign to push a water filter advertisement to the device based on the location, type of device, whereas a different type of advertisement (or no advertisement at all) would be selected if the user is at home or not in proximity to the particular retail store, or a different retail store.

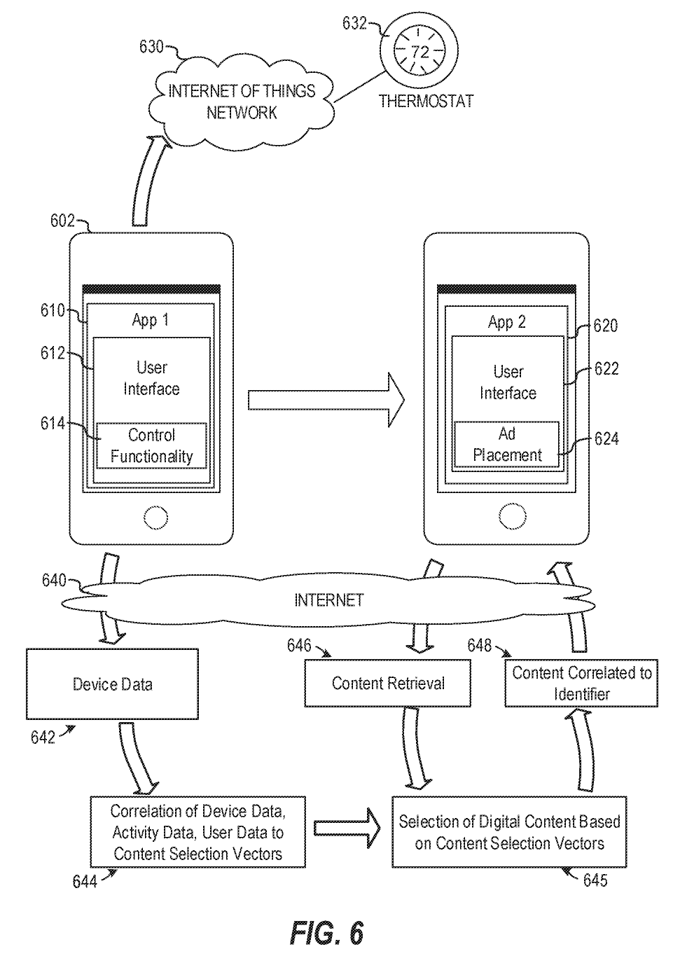

FIG. 6 illustrates an example scenario of accessing customized content in a media network, based on control of a smart device from a software application, according to an example. As shown, a smart device 632 is operated via an internet of things network 630, via control functionality 614 in the user interface 612 of a first software application 610. The first software application 610 operates on the mobile computing device 602, and may be a software application that is provided by the device manufacturer, or smart home service provider, for specific control and monitoring of the device 632. The control functionality 614 may include various network commands that are sent via a local or wide area communications network (not shown), to the IoT network 630, to ultimately interact with the smart device 632.

The data from the smart devices may be collected in the IoT media platform as device data 642, and include at least one user identifier, device identifier, or identifying data field. For example, a connection via a cloud service 640 may communicate the commands and status information from the first application 610, or such information may be received directly from the device. In the cloud service 640 (e.g., connected to a IoT media platform), operations are performed to correlate device data with activity data and user data, with such data fields as are relevant to content selection vectors and vector data.

Based on the correlation and association of device data with a particular user, device, activity, and other vector items, content may be selected for display in a second software application 620. This second software application 620 may include a user interface 622 that hosts advertisement content 624 or other forms of selected (pushed or pulled) content. For instance, the advertisement content 624 may be content that is selected for the user based on specific IoT smart device activity vectors, such as with the usage and activity scenarios discussed above.

In a specific example, the second application 620 may initiate a request 646 to obtain content (e.g., advertising content), based on an identifier associated with the user or the user's device. As a result of the correlation 644, the selection of digital content 645 for this identifier may be determined. The selection of digital content 645 provides a set of content 648 correlated to at least one identifier and the data vectors, which can be delivered to the second application 620.

The placement of the advertising content 624 may be interactive, and manually or automatically launched in response to user activity in the second software application 620. In some examples, other fields of monitoring and device information (e.g., collected and retrieved from the first software application 610) may be locally stored on the mobile computing device 602 and used for further customization or refinement of the content displayed within the second software application 620. However, the preceding techniques may also be used with separate computing devices, with a first device used to control the IoT device versus a second device access the targeted information.

Also in some examples, the fields of monitoring and device information are correlated to advertising network uses for mobile advertising platforms such as Apple's iAd, Google's AdMob or AdSense, or like targeted media platforms. With use of a larger mobile advertising platform, advertisements and other targeted content may be provided to multiple types or forms of network-connected devices that are associated with the user (including a television, media player, personal computer, laptop, tablet, or the like, which may not directly include smart device control capabilities).

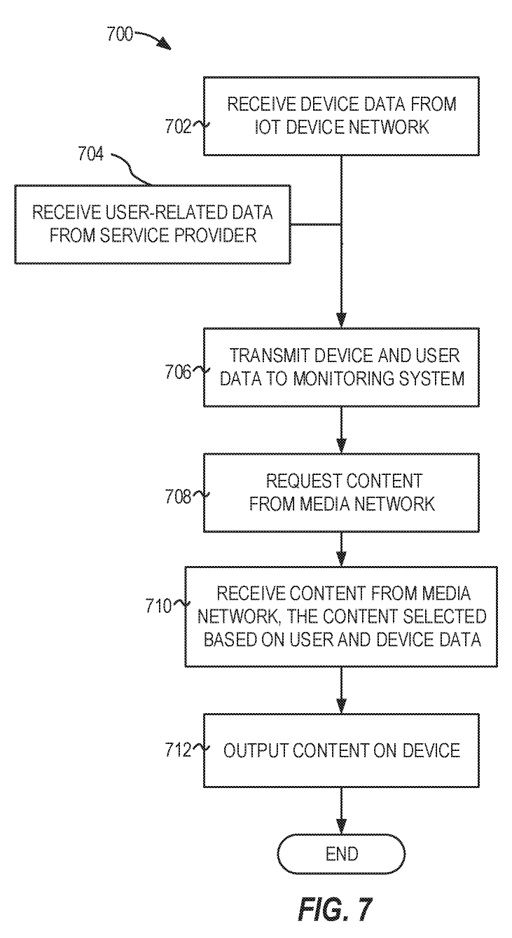

FIG. 7 illustrates an example method 700 performed by one or more computing systems for content retrieval from an IoT media platform according to an example described herein. The method 700 may be implemented in hardware or software within one or more electronic systems; and in some examples, the operations of method 700 may be split across multiple entities. For example, the method 700 may be embodied by a non-transitory machine-readable medium including instructions, or one or more data processing, communication, and display components implemented in connection with a hardware processor and a memory. Accordingly, it will be understood that the method 700 may be implemented with a computerized or electronic process that involves minimal or no human interaction.

As illustrated, the method 700 for content retrieval includes operations to obtain (e.g., retrieve, access, or identify) device related data from a processor, memory, communication network, wireless network, or other electronically readable or communicable data source of a smart device of a user (operation 702). This device related data may include a device identifier, user identifier, user data, device usage data, device parameter data, or the like. This device data may be processed by a smart home service provider (for example) and used in connection with identifying device-specific and application-specific activity, including information as indicated by user preferences, user profiles, and device-specific information.

Optionally, the content retrieval includes operations to obtain (e.g., retrieve, access, or identify) user related data from a processor, memory, communication network, wireless network, or other electronically readable or communicable data source of a service provider (operation 704). This user related data may include a user identifier, user data, user profile, or the like. This user-related data may be processed by the computing system and used in connection with device-specific and application-specific activity, including information as indicated by user preferences, user profiles, and device-specific information. The various forms and sets of user and device data, including corresponding identifiers or identifying information, are then provided to a smart device monitoring system (operation 706).

The method 700 further operates to request content from a media network (operation 708) on the basis of the user-related and device-related received data. In response to the request for content, the computing system receives content from the media network (operation 710), the content being selected based on the previously communicated user-related data and device-related data, and corresponding vector information or characteristics defined for the media network.

In response to receiving the content from the media network, further processing may be performed on the content. For example, the received content may be further selected, processed, and refined, such as in response to user preferences, an advertising profile, or settings on the outputting device. Such selection, processing, and or refinement may be provided by an algorithm. Further, in response to receiving the content, the received content may be provided by the output device during a selected period (operation 712) (e.g., as indicated by the vectors). As examples, the received content may be displayed or output from within a portion of a software application, within a user interface of the operating system of a selected device, within a media player of a selected device, or within like audiovisual interfaces of a selected device.

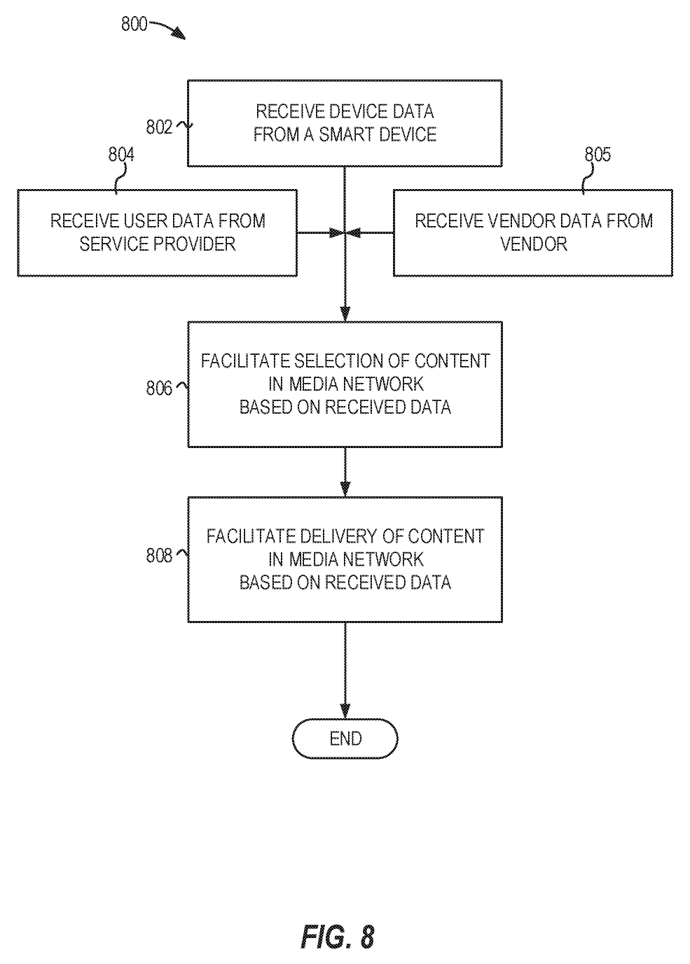

FIG. 8 illustrates an example method 800 performed by one or more computing systems for content retrieval from an IoT media platform (such as an information system) according to an example described herein. The method 800 may be implemented in hardware or software within one or more electronic systems (and as steps in substitute or addition to those of FIG. 7); and in some examples, the operations of method 800 may be split across multiple entities. For example, the method 800 may be embodied by a non-transitory machine-readable medium including instructions, or one or more data processing, communication, and display components implemented in connection with a hardware processor and a memory. Accordingly, it will be understood that the method 800 may be implemented with a computerized or electronic process that involves minimal or no human interaction.

As illustrated, the method 800 for content delivery includes operations to receive, process, and facilitate delivery of information based on device activity information from a smart device. As shown, information originates from a smart device, in the form of operations to collect or receive device related data from a smart device of a user (operation 802). For example, the device related data may be received and recorded by a smart device monitoring system and intermediate entities within a network.

The method 800 further operates optionally to receive user related data from a processor, memory, communication network, wireless network, or other electronically readable or communicable data source of a computing device of a service provider (operation 804). The method 800 further operates optionally to receive vendor related data from a processor, memory, communication network, wireless network, or other electronically readable or communicable data source of a computing device of a third party (operation 805).

The information system can further operate to facilitate the selection of content based on the received user data, device data, and/or vendor data. (operation 806). Based on this selection of content, the information system can further operate to facilitate the delivery of the selected content (operation 808) (to the same smart home device, to a related control device, to a computing system) such as through the display of an advertisement in a software application.

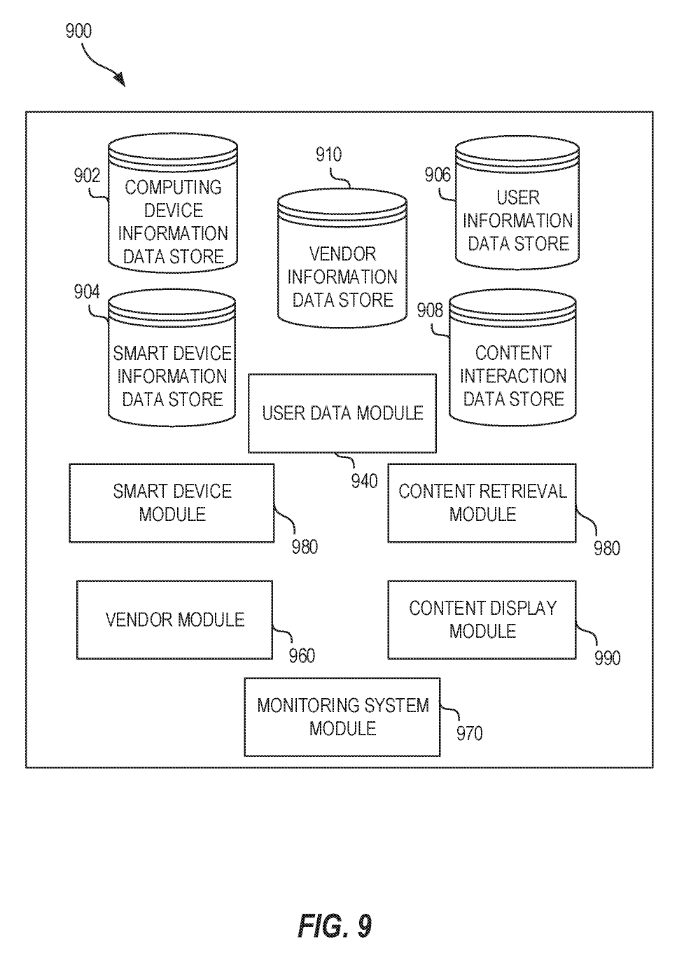

FIG. 9 illustrates a block diagram of a computing system 900 with processing components adapted for interaction with a media network according to a further example. The computing system 900 may include a processor, memory, operating system, and user input interface to operate and provide interaction with the IoT media platform and associated devices, systems, and implementations. The computing system 900 may be implemented within one or a plurality of computer system devices, at one or multiple locations, and be implemented in connection with features of remote or cloud-based processing functions.

The computing system 900 is configured to implement a plurality of modules or components for, data retrieval, content retrieval, and content display according to the functionality described above. The computing system 900 is also configured to implement and maintain a plurality of data stores for storing data used to provide the functionality described above. A description of the following modules and data sources follows, but it will be understood that functionality and operation of the various data sources and modules may be consolidated into fewer or expanded into additional data sources or modules.

The computing system 900 is depicted as including: a computing device information data store 902 for storing or maintaining device information such as a device identifier, device usage data, device location, device profile information or the like; a smart device information data store 904 for storing and maintaining smart device information such as product information, usage and device information, smart device identifiers, and the like; a user information data store 906 for storing user identifiers, user profile information, and the like; and a content interaction data store 908 for storing or maintaining content information such as received media content, content preferences, or content data on the computing system, a vendor information data store 910 for storing and maintaining vendor information such as product information, product improvement information, promotional information, and the like. Additional data stores may also be used to persist, maintain, and receive data involved in the monitoring and media output functions described herein.

The computing system 900 is also depicted as including a series of modules or components providing functionality for implementing the features of a client system for interaction with a monitoring system. The modules or components depicted include: a user module 940 used for providing information to the device monitoring system that is unique to a user associated with a smart device; a smart device module 950 used for monitoring device usage and associated data generated from use of a smart device within a dwelling; a vendor module 960 for receiving vendor data related to vendor products and advertising; a monitoring system module 970 used for receiving information including smart device data, user data, and third party vendor data; a content retrieval module 980 used for retrieving content from the media network that is targeted to the user; and a content display module 990 used to cause the display of the media content.

Embodiments used to facilitate and perform the techniques described herein may be implemented in one or a combination of hardware, firmware, and software. Embodiments may also be implemented as instructions stored on a machine-readable storage medium (e.g., a storage device), which may be read and executed by at least one processor to perform the operations described herein. A machine-readable storage medium may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

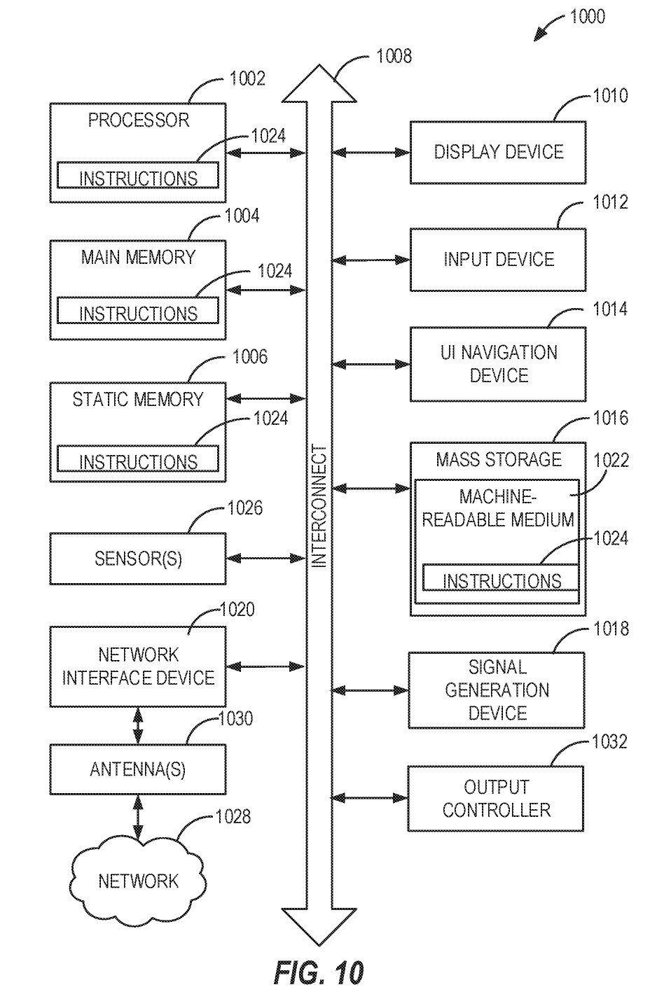

FIG. 10 illustrates a block diagram illustrating a machine in the example form of a computer system 1000, within which a set or sequence of instructions may be executed to cause the machine to perform any one of the methodologies discussed herein, according to an example. Computer system machine 1000 may be embodied by the electronic processing systems implemented by the service providers and networks 102, 110, 112, 210, 510: the devices 126, 128, 602; the content platforms and systems 302, 340, 350, 530; the subsystem(s) implementing the data stores 902, 904, 906, 908, 910: the subsystem(s) implementing the various modules or components 940, 950, 960, 970, 980, 990; or any other electronic processing or computing platform described or referred to herein.

Example computer system 1000 includes at least one processor 1002 (e.g., a central processing unit (CPU), a graphics processing unit (GPU) or both, processor cores, compute nodes, etc.), a main memory 1004 and a static memory 1006, which communicate with each other via an interconnect 1008 (e.g., a link, a bus, etc.). The computer system 1000 may further include a video display unit 1010, an alphanumeric input device 1012 (e.g., a keyboard), and a user interface (UI) navigation device 1014 (e.g., a mouse). In one embodiment, the video display unit 1010, input device 1012 and UI navigation device 1014 are incorporated into a touchscreen interface and touchscreen display. The computer system 1000 may additionally include a storage device 1016 (e.g., a drive unit), a signal generation device 1018 (e.g., a speaker), an output controller 1032, a network interface device 1020 (which may include or operably communicate with one or more antennas 1030, transceivers, or other wireless communications hardware), and one or more sensors 1026, such as a global positioning system (GPS) sensor, compass, accelerometer, location sensor, or other sensor.

The storage device 1016 includes a machine-readable medium 1022 on which is stored one or more sets of data structures and instructions 1024 (e.g., software) embodying or utilized by any one or more of the methodologies or functions described herein. The instructions 1024 may also reside, completely or at least partially, within the main memory 1004, static memory 1006, and/or within the processor 1002 during execution thereof by the computer system 1000, with the main memory 1004, static memory 1006, and the processor 1002 also constituting machine-readable media.

While the machine-readable medium 1022 is illustrated in an example embodiment to be a single medium, the term “machine-readable medium” may include a single medium or multiple media (e.g., a centralized or distributed database, and/or associated caches and servers) that store the one or more instructions 1024. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks: magneto-optical disks; and CD-ROM and DVD-ROM disks.

The instructions 1024 may further be transmitted or received over a communications network 1028 using a transmission medium via the network interface device 1020 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 2G/3G, and 4G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a method for content selection from a media content network, the method performed by a smart device management service, and the method comprising: obtaining device data produced from a smart device, the smart device including a sensor or actuator used in a defined environment, wherein the device data is associated with a user identifier of a user; obtaining vector data defined for delivery of media content, wherein the media content is associated with the smart device, and wherein the vector data identifies a type of user to receive the media content; identifying media content from the media content network, based on the vector data and the device data, wherein the type of user indicated in the vector data is matched using the user identifier associated with the device data; and transmitting the media content to an output device associated with the user, to cause output of the media content on the output device.

In Example 2, the subject matter of Example 1 includes, wherein the smart device is a: television, sound system, media player, speaker, refrigerator, oven, stove, microwave, coffee maker, door lock, window control, camera, pedometer, scale, toothbrush, pill dispenser, personal health monitoring device, or thermostat.

In Example 3, the subject matter of Examples 1-2 includes, wherein the output device is a display output or audio output of the smart device.

In Example 4, the subject matter of Examples 1-3 includes, wherein the vector data indicates multiple vectors, the multiple vectors provided from a combination of at least two vectors that specify: user demographics, user web activity, user location, device location, device activity, device state, or device information.

In Example 5, the subject matter of Example 4 includes, wherein the multiple vectors further specify a real-time vector or a delayed vector, to cause a real-time or a delayed delivery of the media content to the output device.

In Example 6, the subject matter of Examples 1-5 includes, wherein identifying the media content further comprises identifying the media content based on demographic data associated with the user.

In Example 7, the subject matter of Examples 1-6 includes, wherein identifying the media content further comprises identifying the media content based on third party data received by the media content network from a third party vendor, the third party vendor providing further information to identify the user.

In Example 8, the subject matter of Examples 1-7 includes, wherein the device data includes data produced from among multiple smart devices, the multiple smart devices including the smart device, and wherein the vector data further identifies types of smart devices that are associated with respective device types of the multiple smart devices.

In Example 9, the subject matter of Example 8 includes, wherein the vector data indicates delivery characteristics of the media content based on the types of the multiple smart devices, and wherein the media content network includes data obtained from a plurality of content providers.

In Example 10, the subject matter of Examples 8-9 includes, wherein the smart device management service associates the user identifier with multiple identifiers used to access respective devices of the multiple smart devices, wherein the respective devices of the multiple smart devices are accessed via respective network services.

Example 11 includes at least one machine readable medium including instructions, which when executed by device (e.g., computing device, smart device, server device) hardware, cause the device hardware to perform or implement any of the methods of Examples 1 to 10 or other methods discussed herein.

Example 12 is a computing system comprising processing circuitry and a storage device, comprising instructions (including instructions in the form of respective executable modules, components, or logic), that when executed by the processing circuitry, cause the processing circuitry to perform any of the methods of Examples 1 to 10 or other methods discussed herein.

Example 13 includes an apparatus comprising means for performing any of the methods of Examples 1 to 10 or other methods discussed herein.

Example 14 is a system to perform the operations of any of Examples 1 to 13 or other methods discussed herein.

Example 15 is a method to perform the operations of any of Examples 1 to 14 or other methods discussed herein.

Additional examples of the presently described method, system, and device embodiments include the configurations recited by the claims. Each of the examples in the claims may stand on its own, or may be combined in any permutation or combination with any one or more of the other examples provided below or throughout the present disclosure.

What is claimed is:

1. A method for content selection from a media content network, the method performed by a smart device management service, and the method comprising:
obtaining device data produced from a smart device, the smart device including a sensor or actuator used in a defined environment, wherein the device data is associated with a user identifier of a user;
obtaining vector data defined for delivery of media content, wherein the media content is associated with the smart device, and wherein the vector data identifies a type of user to receive the media content;
identifying media content from the media content network, based on the vector data and the device data, wherein the type of user indicated in the vector data is matched using the user identifier associated with the device data and
transmitting the media content to an output device associated with the user, to cause output of the media content on the output device.

2. The method of claim 1, wherein the smart device is a: television, sound system, media player, speaker, refrigerator, oven, stove, microwave, coffee maker, door lock, window control, camera, pedometer, scale, toothbrush, pill dispenser, personal health monitoring device, or thermostat.

3. The method of claim 1, wherein the output device is a display output or audio output of the smart device.

4. The method of claim 1, wherein the vector data indicates multiple vectors, the multiple vectors provided from a combination of at least two vectors that specify: user demographics, user web activity, user location, device location, device activity, device state, or device information.

5. The method of claim 4, wherein the multiple vectors further specify a real-time vector or a delayed vector, to cause a real-time or a delayed delivery of the media content to the output device.

6. The method of claim 1, wherein identifying the media content further comprises identifying the media content based on demographic data associated with the user.

7. The method of claim 1, wherein identifying the media content further comprises identifying the media content based on third party data received by the media content network from a third party vendor, the third party vendor providing further information to identify the user.

8. The method of claim 1, wherein the device data includes data produced from among multiple smart devices, the multiple smart devices including the smart device, and wherein the vector data further identifies types of smart devices that are associated with respective device types of the multiple smart devices.

9. The method of claim 8, wherein the vector data indicates delivery characteristics of the media content based on the types of the multiple smart devices, and wherein the media content network includes data obtained from a plurality of content providers.

10. The method of claim 8, wherein the smart device management service associates the user identifier with multiple identifiers used to access respective devices of the multiple smart devices, wherein the respective devices of the multiple smart devices are accessed via respective network services.

11. At least one non-transitory machine-readable storage medium including instructions for content selection in a content media network, comprising instructions, that when executed by a computing system, cause the computing system to:
process device data produced from a smart device, the smart device including a sensor or actuator used in a defined environment, wherein the device data is associated with a user identifier of a user;
process vector data defined for delivery of media content, wherein the media content is associated with the smart device, and wherein the vector data identifies a type of user to receive the media content;
identify media content from the media content network, based on the vector data and the device data, wherein the type of user indicated in the vector data is matched using the user identifier associated with the device data; and
transmit the media content to an output device associated with the user, to cause output of the media content on the output device.

12. The machine-readable storage medium of claim 11, wherein the smart device is a: television, sound system, media player, speaker, refrigerator, oven, stove, microwave, coffee maker, door lock, window control, camera, pedometer, scale, toothbrush, pill dispenser, personal health monitoring device, or thermostat.

13. The machine-readable storage medium of claim 11, wherein the output device is a display output or audio output of the smart device.

14. The machine-readable storage medium of claim 11, wherein the vector data indicates multiple vectors, the multiple vectors provided from a combination of at least two vectors that specify: user demographics, user web activity, user location, device location, device activity, device state, or device information.

15. The machine-readable storage medium of claim 14, wherein the multiple vectors further specify a real-time vector or a delayed vector, to cause a real-time or a delayed delivery of the media content to the output device.

16. The machine-readable storage medium of claim 11, the instructions further to cause the computing system to:
identify the media content based on demographic data associated with the user; and
identify the media content based on third party data received by the media content network from a third party vendor, the third party vendor providing further information to identify the user.

17. The machine-readable storage medium of claim 11, wherein the device data includes data produced from among multiple smart devices, the multiple smart devices including the smart device, and wherein the vector data further identifies types of smart devices that are associated with respective device types of the multiple smart devices.

18. A computing system, comprising:
processing circuitry;
a storage device, comprising instructions, that when executed by the processing circuitry, cause the processing circuitry to:
process device data produced from a smart device, the smart device including a sensor or actuator used in a defined environment, wherein the device data is associated with a user identifier of a user;
process vector data defined for delivery of media content,
wherein the media content is associated with the smart device, and wherein the vector data identifies a type of user to receive the media content;
identify media content from a media content network, based on the vector data and the device data, wherein the type of user indicated in the vector data is matched using the user identifier associated with the device data; and
transmit the media content to an output device associated with the user, to cause output of the media content on the output device.

19. The computing system of claim 18, wherein the smart device is a: television, sound system, media player, speaker, refrigerator, oven, stove, microwave, coffee maker, door lock, window control, camera, pedometer, scale, toothbrush, pill dispenser, personal health monitoring device, or thermostat.

20. The computing system of claim 18, wherein the output device is a display output or audio output of the smart device.

21. The computing system of claim 18, wherein the vector data indicates multiple vectors, the multiple vectors provided from a combination of at least two vectors that specify: user demographics, user web activity, user location, device location, device activity, device state, or device information.

22. The computing system of claim 18, wherein the device data includes data produced from among multiple smart devices, the multiple smart devices including the smart device, and wherein the vector data further identifies types of smart devices that are associated with respective device types of the multiple smart devices.
